(19) United States
(12) Patent Application Publication
(10) Pub. No.: US 2022/0348081 A1
(43) Pub. Date: Nov. 3, 2022

(54) Presentation of Information on Board a Vehicle

(71) Applicant: Bayerische Motoren Werke Aktiengesellschaft, Muenchen (DE)

(72) Inventors: Gunnar FRANZ, Ottobrunn (DE); Philipp HOFFMANN, Hannover (DE); Jasper STERN, Muenchen (DE)

(21) Appl. No.: 17/733,437

(22) Filed: Apr. 29, 2022

(30) Foreign Application Priority Data
Apr. 30, 2021 (DE) 10 2021 111 216.8

(51) Int. Cl. B60K 35/00; G06V 20/59

(52) U.S. Cl. CPC B60K 35/00; G06V 20/597; B60K 2370/149; B60K 2370/1529; B60K 2370/184; B60K 2370/52; B60K 2370/67; B60K 2370/685; B60K 2370/741; B60K 2370/782

(57) ABSTRACT

An apparatus for providing information on board a vehicle includes a first display; a second display; a scanning device for capturing a position of a person on board the vehicle; and a processing device. The processing device is configured to: determine a constellation in which the second display is located between the first display and the person; determine a display content of the first display that is covered by the second display; and provide the determined display content on the second display.

### CROSS REFERENCE TO RELATED APPLICATION

This application claims priority under 35 U.S.C. § 119 from German Patent Application No. DE 10 2021 111 216.8, filed Apr. 30, 2021, the entire disclosure of which is herein expressly incorporated by reference.

### BACKGROUND AND SUMMARY

The invention relates to the presentation of information on board a vehicle. In particular, the invention relates to the presentation of information provided on a temporarily obscured display.

A vehicle comprises a display device for a driver. The display device is attached in front of the driver and can comprise a typical circular instrument, a multifunction display or a head-up display (HUD), and the driver therefore need not take their gaze away from, or not far from, traffic events to read the display device.

The display device can, for example, relate to a driving parameter, for example a driving speed, a warning, for example before an unintentional lane departure, or a message relating to the navigation of the vehicle. The presentation of specific information to the driver may be prescribed. If a piece of information does not reach the driver, the driving safety of the vehicle may be at risk.

Known display devices might not be readable by the driver in all driving situations. For example, if the display device is located from the driver's viewpoint on the other side of a steering wheel, the steering wheel can obscure part of the display device during driving through a bend, for example. The driver on board can also move in a manner such that a portion of the display device is obscured from their viewpoint by the steering wheel or another object.

An object on which the invention is based is to provide improved technology for providing visual information to a driver of a vehicle. The invention achieves the object by means of the subject matter of the independent claims. Preferred embodiments are specified in the dependent claims.

According to a first aspect of the present invention, an apparatus for providing information on board a vehicle comprises a first display; a second display; a scanning device for capturing a position of a person on board the vehicle; and a processing device. The processing device is here configured to determine a constellation in which the second display is located between the first display and the person; to determine a display content of the first display that is covered by the second display; and to provide the determined display content on the second display.

The person in particular relates to a driver of the vehicle. The displays are typically arranged in a visual field of the driver, wherein distances between the driver and the displays may differ. In a predetermined driving situation, the displays cannot overlap from a position of the driver. In this case, a display area of the second display can be ready to present further information.

However, if the described constellation arises for example because the driver moves in relation to the displays or because one of the displays moves in relation to the driver and to the other display, it can be ensured that the obscured display content of the first display is displayed to the driver on the second display.

From the perspective of the person, the presentation on the second display can tie in with or continue a presentation on the first display, with the result that the information presented can be perceived well by the driver on the whole. The information can be provided numerically, graphically, or symbolically and can comprise for example a driving parameter, a warning message, or a driving message. The information can be provided in an improved manner dynamically in dependence on a situation on board the vehicle, with the result that the driver is better informed and the safety of the vehicle can be increased.

The first display is preferably immovably attached to the vehicle or is configured to display information at a fixed point with respect to the vehicle. For example, the first display can be attached in a console or a dashboard and comprise for example a graphic display such as an LCD or LED display. In a further embodiment, the first display can also comprise a head-up display, wherein it is assumed for the purposes of this invention that a visual presentation provided by the head-up display is at a constant position with respect to the vehicle, even if the position may be located outside the vehicle from the perspective of the person.

The second display can be attached movably in the vehicle, wherein the apparatus furthermore comprises a device for determining a position of the second display. In particular, the second display can be attached to a movable object in the vehicle, with further preference to an operating element of the vehicle. The object can be rendered practically transparent for the person by the second display, with the result that the person can discern the visual information presented on the first display independently of a position of the object. It is preferred in this case for the second display to cover as large a part of the object as possible in the region in which the latter can obscure the first display. The part of the object that is not covered by the second display can be relatively small or obscure a relatively small portion of the first display, with the result that visibility of the information can be ensured.

This opens up a greater range of possible designs for the virtually transparent object. The object can thus have a better ergonomic design, without the need to take the readability of the first display into consideration.

The second display can be attached in particular to a steering wheel of the vehicle. The steering wheel can be used by the driver for laterally controlling the vehicle. The steering wheel can be typically round or oval or have a more innovative shape such as a H-shaped handle or be a yoke. Further options comprise a joystick. The steering wheel is preferably rotatable, and the device comprises a sensor for determining a steering wheel angle. If the steering wheel is movable on the vehicle in a different way, for example is pivotable, tiltable or displaceable, a sensor for determining a pivot angle, a tilt angle or a displacement can be provided accordingly.

The steering wheel is typically attached between the driver and the first display. By providing the steering wheel with the second display, it is possible to more freely design the steering wheel, for example to provide a better design for accident prevention or ergonomics.

The scanning device preferably comprises an interior camera of the vehicle. The interior camera can already be provided on board the vehicle for other reasons, for example to determine whether the driver is tired.

According to a further aspect of the present invention, a vehicle comprises an apparatus described herein. The vehicle can comprise in particular a motor vehicle, for example a motorcycle, a passenger vehicle, a truck or a bus.

According to a further aspect of the present invention, a method for providing information on board a vehicle by means of a first and a second display comprises steps of determining a constellation in which the second display is located between a person on board the vehicle and the first display; of determining a display content of the first display that is covered by the second display; and of providing the determined display content on the second display.

The method can be carried out entirely or partially by means of an apparatus described herein. The apparatus can here comprise a programmable microcomputer or microcontroller, and the method can be present in the form of a computer program product having program code means. The computer program product can also be stored on a computer-readable data carrier. Features or advantages of the method can be transferred to the apparatus, or vice versa.

Determining the constellation can comprise determining a position of the head of the person on board the vehicle. A scan of the interior of the vehicle can be processed to find the head of the person. In one embodiment, a position of the head can be determined in only one direction, in particular in the vertical or horizontal direction, or with respect to a distance from the display. However, the position of the head is preferably determined in multiple directions.

Determining the constellation can also comprise determining a position of an eye of the person on board the vehicle. A parallax error for the person can thereby be minimized. The position of the eye can be determined by means of a device for determining a viewing direction of the person, in particular on the basis of an optical scan of the interior of the vehicle. The eye can comprise in particular a dominant eye or a leading eye of the person. The person can indicate themselves which eye is their leading eye, or the leading eye can be determined by observing the person. In particular, the hand-eye coordination of the person when operating an operating element of the vehicle can be optically captured, and it is possible to infer from the capturing operation which eye of the person is the preferred eye and can be considered to be the leading eye. In a further embodiment, always a position of the left eye or always a position of the right eye of the person can be determined.

Determining the constellation can furthermore comprise determining a pose of the second display. If the second display is attached to a movable object, the movability of the object can be restricted in a predetermined manner. For example, a second display attached to a steering wheel can be rotated only about one predetermined axis of rotation. By taking account of the pose, a position and an alignment of the second axis can be taken into account, with the result that the presentation content taken over on the second display from the first display can be presented in the correct orientation.

A determined display content can be provided on the second display only if a priority of the determined display content is greater than a priority of a display content of the second display. This is in order to be able to ensure that a less important piece of information does not cover a more important piece of information or replace it in a presentation. The priority can be dynamically determined in dependence on a presented display content, with the result that it is better possible to flexibly present information on the displays.

The principle of the priorities can also be extended to objects that are presented on the first display. The obscured display content can comprise multiple objects with respectively assigned priorities; wherein in a further embodiment only objects whose priority is greater than a priority of a display content of the second display are provided on the second display. If the second display obscures two different objects of the first display, it is possible for a first obscured object to be overlaid on the display content of the second display while a second obscured object is not. In this way, a finely grained gradation of presentation priorities can be realized. Assigning priorities to objects can be done by the person.

In yet a further embodiment, an object of the first display can be overlaid on a display content of the second display. A reverse embodiment is likewise conceivable, in which an object of the first display is displayed on the second display behind an object that is presented there. An object of the first display can thus form a background to an object presented on the second display. In a further embodiment, an overlaying object can also be presented on the second display as being partially transparent.

Even on the second display, objects can be presented with different priorities. A first object of the first display can be overlaid on an object on the second display only if the priority of the first object exceeds that of the second object. An overlaid object may not be presented only in the region of the overlaying object, and as a result a not-overlaid portion is still visible, or the presentation of the overlaid object can be omitted entirely.

Other objects, advantages and novel features of the present invention will become apparent from the following detailed description of one or more preferred embodiments when considered in conjunction with the accompanying drawing.

### BRIEF DESCRIPTION OF THE DRAWINGS

FIG. 1 illustrates a vehicle having a display apparatus;

FIG. 2 illustrates exemplary presentations on two displays; and

FIG. 3 illustrates a flowchart of a method.

### DETAILED DESCRIPTION OF THE DRAWINGS

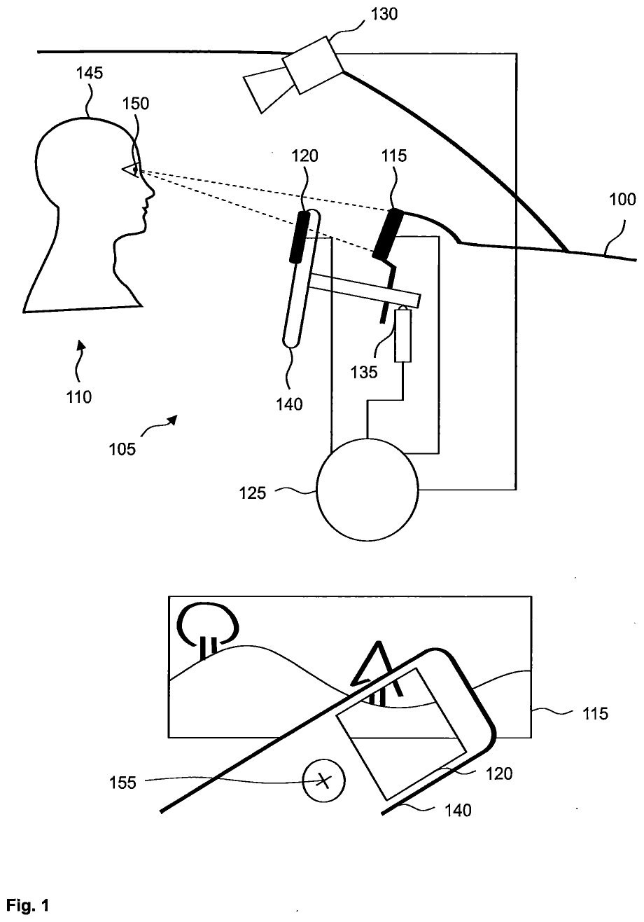

FIG. 1 shows in an upper part a vehicle 100 having an apparatus 105 for presenting information to a person 110 on board the vehicle 100. The apparatus 105 comprises a first display 115, a second display 120 and a processing device 125. Furthermore provided are preferably a scanning device 130 and/or a sensor 135.

The person 110 can comprise in particular a driver of the vehicle 100. The displays 115, 120 are each configured to present visual and in particular graphically representable information to the person 110. Such information can comprise for example a driving situation of the vehicle 100. It is assumed that the processing device 125 provides information to be presented, although it can also receive such information from a different source, for example from a further control unit on board the vehicle 100.

The first display 115 is preferably firmly attached to the vehicle 100, and the second display 120 can be movably attached to the vehicle 100. Distances of the displays 115, 120 from the person 110 can differ. In an embodiment, a display area of the first display 115 is larger than a display area of the second display 120.

The second display 120 may be movable by being attached to an object that is movable in the vehicle 100. In the present case, the second display 120 is attached to a steering wheel 140, for example in a central region or to a spoke of the steering wheel 140. In an embodiment, the second display 120 may be touch-sensitive so as to allow a control input from the person 110. The sensor 135 is configured to determine a position and/or an alignment of the second display 120 relative to the vehicle 100. In the present case, the sensor 135 comprises a steering wheel sensor.

The person 110 can be scanned by means of the scanning device 130, and a position of the person 110 on board the vehicle 100 can be determined on the basis of the scan. The position can relate in particular to the head 145 and with further preference to an eye 150 of the person 110. The scanning device 130 can comprise a camera, a stereo camera or a depth camera. The position is preferably determined three-dimensionally with respect to the vehicle 100.

The processing device 125 is configured to determine a constellation of the person 110—or of the person's head 145 or the person's eye 150—in relation to the displays 115 and 120. In particular, the intention is to determine whether the second display 120 is located between the person 110 and the first display 115. In this case, the second display 120 obscures at least a portion of the first display 115 for the person 110. A display content presented on the first display 115 can then be provided on the second display 120. As a result, a content presented on the first display can be continued on the second display 120 for the person 110. The person 110 may be given the impression that the second display 120 is part of the first display 115 and that there is no obscuration.

In a lower region of FIG. 1, the intended effect is illustrated by way of example. In this case, the steering wheel 140 has, by way of example, a substantially rectangular shape in the manner of a yoke and is rotatable about an axis of rotation 155. If the steering wheel 140 due to its rotation about the axis of rotation 155 obscures the first display, a display content of the first display 115, which serves as an example, is continued as seamlessly as possible on the second display 120. The presentation on the second display 120 is effected in the correct orientation and in the region that is obscured in the first display 115 for the driver 110. The presentations of the displays 115 and 120 can together form a uniform presentation. The presentation can be interrupted only in a portion where the first display 115 is obscured by the steering wheel 140 but where the steering wheel 140 is not covered by the second display 120.

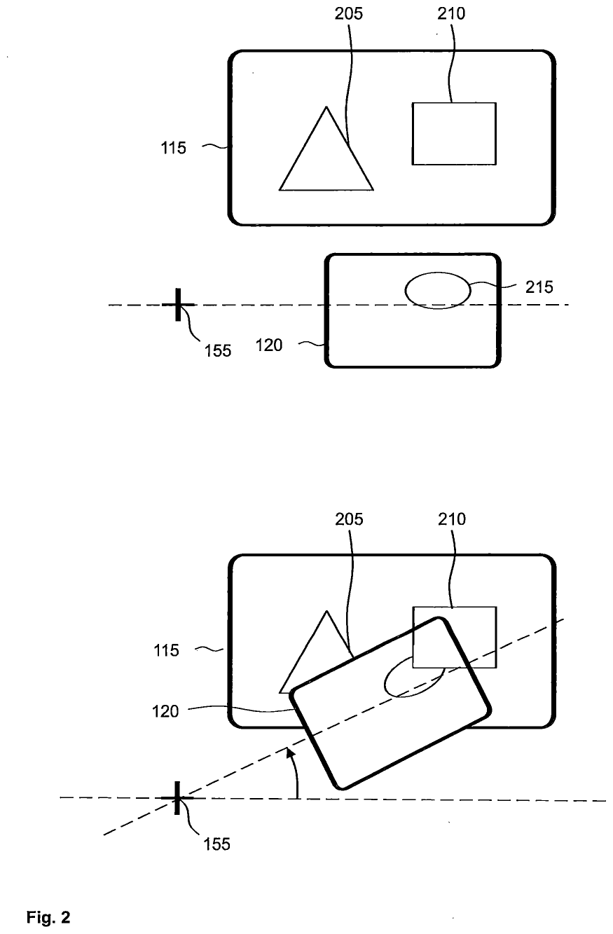

FIG. 2 shows exemplary presentations on a first display 115 and a second display 120. Here, too, a second display 120 that is rotatable about an axis of rotation 155 and obscures, in dependence on an angle of rotation, different portions of the first display 115 is assumed. In an upper region of FIG. 2, the first display 115 is presented as not being obscured and as being partially obscured by the second display 120 in a lower region.

A first object 205 and a second object 210 are presented on the first display 115, and a third object 215 is presented on the second display 120. So as not to completely replace the presentation of the third object 215 on the second display with the presentation of a portion of the display content of the first display 115, it is possible to proceed object by object. For this purpose, the objects 205-215 can each be assigned a priority that decides which object 205-215 can be overlaid on another object 205-215. In the present presentation, for example a priority of the second object 210 is greater than a priority of the third object 215, and the second object 210 is therefore overlaid on or obscures or replaces the third object in the presentation on the second display 120.

Likewise by way of example, the first object 205 has a lower priority than the display content of the second display 120, and for this reason it is not presented at all on the second display 120.

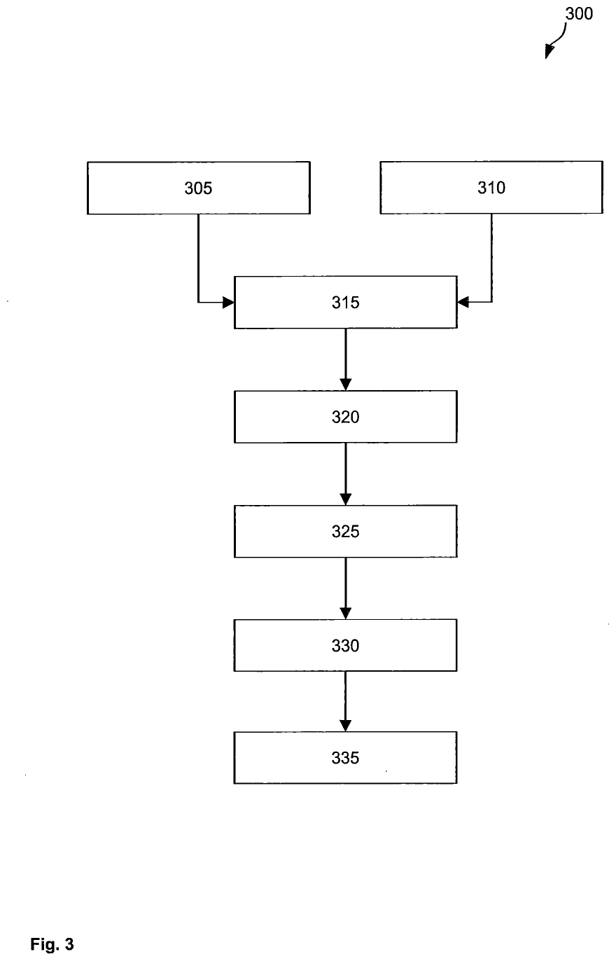

FIG. 3 shows a flowchart of a method 300 for providing information on a second display 120, which temporarily covers the first display 115 from the perspective of a person 110. The focus is here by way of example on the apparatus 105 of FIG. 1, even though in other embodiments other movements are possible or other devices can be used to determine a position or a movement.

In a step 305, a steering wheel angle of the steering wheel 140 to which the second display 120 is attached is scanned. On the basis of the steering wheel angle, a position and an alignment of the second display 120 relative to the vehicle 100 can be determined.

In a step 310, a position of the driver 110, preferably of the driver's head 145 and with further preference of a driver's eye 150, is determined. The position can be determined in particular on the basis of an optical scan by means of the scanning device 130.

In a step 315, a constellation indicating how the person 110, the second display 120, and the first display 115 are located in the vehicle is determined. On the basis of the constellation, it is possible to determine which portion of the first display 115 is covered by the second display 120 from the perspective of the driver 110. It is furthermore possible to determine which portion of the second display 120 covers the first display 115.

In a step 320, objects 205, 210, which are presented on the first display 115, and respectively assigned priorities can be determined. In a step 325, an object 215, which is presented on the second display 120, and an assigned priority can be determined. In an embodiment, an entire display content of one of the displays 115, 120 can also be considered to be the object 205-215.

In a step 330, it is possible to determine, for a portion of the second display 120 that covers a portion of the first display 115, which object 215 presented on the second display 120 is overlaid by or on an object 205, 210 of the first display 115. The display content of the first display 115 can for this reason be imaged onto a display area of the second display 120 by means of a transformation matrix, which can be determined on the basis of the steering angle.

In a step 335, objects 205-215 can be provided on the second display 120 in accordance with the determined overlay.

In order to take into account that the position and/or alignment of the second display 120 relative to the first display 115, and also the position of the person 110 relative to the displays 115, 120, can change quickly, it is preferred that a rotational speed and possibly also a rotational acceleration of the steering wheel 140 are taken into account for the determination of a display content that is to be presented on the second display 120. A position and/or alignment of the second display 120 can also be predicted for a future time point.

Typically, a display 115, 120 on board the vehicle 100 is supplied with frames, which are then provided by the displays 115, 120, at a predetermined frequency. A piece of information that is to be presented on the second display 120 can be determined on the basis of a frame that has been prepared for the visual presentation but has not yet been presented. Information to be presented can thus be synchronized better with respect to one another on the displays 115, 120 and take into account changing circumstances in the constellation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 Vehicle
105 Apparatus
110 Person
115 First display
120 Second display
125 Processing device
130 Scanning device
135 Sensor
140 Steering wheel
145 Head
150 Eye
155 Axis of rotation
205 First object
210 Second object
215 Third object
300 Method
305 Scanning steering wheel angle
310 Determining position of the driver
315 Determining constellation
320 Determining objects and priorities of the display content of the first display
325 Determining objects and priorities of the display content of the second display
330 Determining overlaid objects for the first display
335 Providing overlaid objects

What is claimed is:

1. An apparatus for providing information on board a vehicle, comprising:
a first display;
a second display;
a scanning device for capturing a position of a person on board the vehicle;
a processor configured to determine a constellation in which the second display is located between the first display and the person,
wherein the processor is further configured to determine a display content of the first display that is covered by the second display and to provide the determined display content on the second display.

2. The apparatus according to claim 1, wherein
the first display is movably attached in the vehicle, and
wherein the apparatus further comprises a device for determining a position of the second display.

3. The apparatus according to claim 2, wherein
the second display is attached to a rotatable steering wheel of the vehicle and the determining device comprises a sensor for determining a steering wheel angle.

4. The apparatus according to claim 1, wherein
wherein the scanning device comprises an interior camera of the vehicle.

5. A vehicle comprising an apparatus according to claim 1.

6. A method for providing information on board a vehicle via a first and a second display, the method comprising:
determining a constellation in which the second display is located between a person on board the vehicle and the first display;
determining a display content of the first display that is covered by the second display; and
providing the determined display content on the second display.

7. The method according to claim 6, wherein determining the constellation comprises determining a position of the head of the person on board the vehicle.

8. The method according to claim 6, wherein determining the constellation comprises determining a position of an eye of the person on board the vehicle.

9. The method according to claim 6, wherein determining the constellation comprises determining a pose of the second display.

10. The method according to claim 6, wherein
a determined display content is provided on the second display only when a priority of the determined display content is greater than a priority of a display content of the second display.

11. The method according to claim 6, wherein
the covered display content comprises multiple objects with respectively assigned priorities, and
only objects whose priority is greater than a priority of a display content of the second display are provided on the second display.

12. The method according to claim 11, wherein an object of the first display is overlaid on a display content of the second display.
